(19) United States
(12) Patent Application Publication
(10) Pub. No.: US 2020/0102668 A1
(43) Pub. Date: Apr. 2, 2020

(54) COTTON SEED PROCESSING

(71) Applicant: Monsanto Technology LLC, St. Louis, MO (US)

(72) Inventors: Dustin C. Ahearn, St. Peters, MO (US); Gregory A. Boyce, Wentzville, MO (US); Lindsey A. Buntin, Lubbock, TX (US); Dustin Cole, St. Charles, MO (US); Matthew J. Francis, St. Louis, MO (US); Katie M. Gray, St. Louis, MO (US); Sheila Hobbs, Imperial, MO (US); Peter Kevin Parker, Glendale, MO (US)

(21) Appl. No.: 16/585,272

(22) Filed: Sep. 27, 2019

Related U.S. Application Data
(60) Provisional application No. 62/737,590, filed on Sep. 27, 2018.

(51) Int. Cl. D01B 1/06; A01C 1/06; A01C 1/08

(52) U.S. Cl. CPC D01B 1/06; A01C 1/08; A01C 1/06

(57) ABSTRACT

A method of processing cottonseed includes applying an acid solution to a quantity of fuzzy cottonseed within an acid application device. Transferring the quantity of fuzzy cottonseed to a fluid bed dryer station after applying the acid solution. At least partially drying the quantity of fuzzy cottonseed at the fluid bed dryer station.

### CROSS-REFERNCE TO RELATED APPLICATION

This application claims priority to U.S. Provisional Patent Application Ser. No. 62/737,590, filed Sep. 27, 2018, which is hereby incorporated by reference in its entirety.

### BACKGROUND OF THE DISCLOSURE

The present disclosure generally relates to cotton seed processing, such as a large cotton seed processing plant, including one or more stations for processing cotton seed to ready it for shipping to customers for planting.

Cotton ginning processes separate cotton fibers from the cotton seeds. The cotton seed after the ginning process is typically called “fuzzy cottonseed” because it includes lint (i.e., linters) that is still attached to a hull of the cottonseed. The fuzzy cottonseed is typically processed before being sold as plantable cottonseed. For example, the cottonseed is first “delinted” to remove the residual lint (i.e., linters). After delinting, the seed can be handled, inspected, treated with seed treatment, and packaged for shipment to the customer for planting.

### SUMMARY OF THE DISCLOSURE

In one aspect, a method of processing cottonseed generally comprises applying an acid solution to a quantity of fuzzy cottonseed within an acid application device. Transferring the quantity of fuzzy cottonseed to a fluid bed dryer station after applying the acid solution. At least partially drying the quantity of fuzzy cottonseed at the fluid bed dryer station.

In another aspect, a method of processing cottonseed generally comprises applying an acid solution to a quantity of fuzzy cottonseed within an acid application device. Transferring the quantity of fuzzy cottonseed to a seed washing station including a bath of liquid and a transporter running through the bath after applying the acid solution. Washing the quantity of fuzzy cottonseed in the bath of liquid by submerging the cottonseed in the bath of liquid and transporting the cottonseed through the bath with the transporter.

In yet another aspect, a method of processing cottonseed generally comprises applying an acid solution to a quantity of fuzzy cottonseed within an acid application device. Transferring the quantity of fuzzy cottonseed to a seed neutralization station including a neutralization device after applying the acid solution. Neutralizing the acid solution on the quantity of fuzzy cottonseed in the neutralization device by at least one of submerging the cottonseed in a neutralization solution bath and spraying a neutralization solution on the cottonseed in the neutralization device.

In still another aspect, a seed processing system generally comprises an acid application station including an acid application device for applying an acid solution to a quantity of fuzzy cottonseed. A neutralization station includes a neutralization device for neutralizing the acid solution on the quantity of fuzzy cottonseed. A fluid bed dryer station includes a fluid bed dryer for drying, at least partially, the quantity of fuzzy cottonseed.

### BRIEF DESCRIPTION OF THE DRAWINGS

FIG. 1A is a first portion of a flow diagram of one embodiment of cottonseed processing, including representations of stations of a cottonseed processing plant;

FIG. 1B is a second portion of the flow diagram;

FIG. 2 is a schematic of a fuzzy seed receiving station of the cottonseed processing plant;

FIGS. 3A and 3B are schematics of a fuzzy seed storage station of the cottonseed processing plant;

FIG. 4A is a schematic of an acid application station of the cottonseed processing plant;

FIG. 4B is a perspective of horizontal drum of the acid application station;

FIG. 5 is a schematic of a fuzzy seed fluid bed dryer station of the cottonseed processing plant;

FIG. 6A is a schematic of a buffing drum station of the cottonseed processing plant;

FIG. 6B is a cross section of a buffing drum of the buffing drum station;

FIG. 6C is an enlarged fragmentary elevation of FIG. 6B showing a paddle of the buffing drum;

FIG. 6D is another cross section of the buffing drum;

FIG. 6E is an enlarged fragmentary elevation of FIG. 6D showing the paddle of the buffing drum;

FIG. 6F is an elevation of a paddle of the buffing drum;

FIG. 7 is a schematic of a seed cleaner station of the cottonseed processing plant;

FIG. 8 is a schematic of a seed wash/neutralization station and a bypass station of the cottonseed processing plant;

FIG. 9 is a schematic of a delinted seed fluid bed dryer station of the cottonseed processing plant;

FIG. 10 is a schematic of a gravity table station of the cottonseed processing plant;

FIG. 11 is a schematic of a color sorting station of the cottonseed processing plant;

FIG. 12 is a schematic of a delinted seed bulk storage station of the cottonseed processing plant;

FIG. 13 is a schematic of a pre-treatment station of the cottonseed processing plant;

FIG. 14 is a schematic of a seed treatment station of the cottonseed processing plant;

FIG. 15 is a schematic of a bagging bin station of the cottonseed processing plant;

FIG. 16 is a schematic of a bagging/packaging station of the cottonseed processing plant;

FIG. 17 is a perspective of the bypass station of the cottonseed processing plant;

FIG. 18 is a perspective of a neutralization device of the bypass station; and

FIG. 19 is the perspective of FIG. 18 with portions removed showing internal detail.

Corresponding reference characters indicate corresponding parts throughout the drawings.

### PARTS LIST

The below parts list corresponds to corresponding components in the drawings.
100—fuzzy seed sampling/testing station
200—fuzzy seed receiving station

T—trailer

202—screw conveyor

204—dump door

206—bucket elevator
300—fuzzy seed storage station

302—belt conveyor system

304—storage bins

306—longitudinal belt

308—tripper car

310—aeration system

314—seed transfer system

316—walking floor bin

317—level transmitter

318—screw conveyors

320—bucket elevator

321—multi-variance motor

322—inclined belt conveyor
400—acid application station

402—horizontal drum

403—internal baffles

404—spray bar

406—weighing input conveyor

407—multi-variance motor

408—vertical chute

412—acid mixer

414—source of concentrated acid

416—source of a surfactant

418—source of recycled acid
500—fuzzy seed fluid bed dryer (FS-FBD) station

502—fluid bed dryer

504—moisture sensor

506—cyclone
600—buffing drum station

602—transfer device

604—buffing drum

606—agitation paddles

608—position switch

610—flow sensor

612—vibratory mechanism
700—seed cleaner station

702—bucket elevator

704—surge collector

706—air screen cleaner

708—cull collection
800—seed wash/neutralization station

801—conveyor

802—surge bin

804—sampler

806—bath

808—bath

810—conveyor

812—conveyor

813—side guarding

814—heated air

816—sediment conveyor

AR—line for acid-water recovery

AN—line for acid-neutralization disposal
800′—bypass station

803′—neutralization device

805′—inlet

807′—outlet

809′—treater body

811′—rotary weldment

813′—tube

815′—mist disc
900—delinted seed fluid bed dryer station

902—fluid bed dryer

904—moisture sensor
1000—gravity table station

1002—cup elevator

1004—surge bin

1006—first gravity table

1008—second gravity table
1100—color sorting station

1102—NIR analyzer

1104—NIR analyzer
1200—delinted seed bulk storage

1202—tripper belt conveyor

1204—storage bin

1300—pre-treatment station

1302—aspirators
1400—seed treatment station

1402—seed treater
1500—bagging bin station

1502—bins
1600—bagging/packaging station

1602—bagging machine

1604—bagging conveyor

1606—belt cleaner
1700—dust collection system

### DETAILED DESCRIPTION OF THE DISCLOSURE

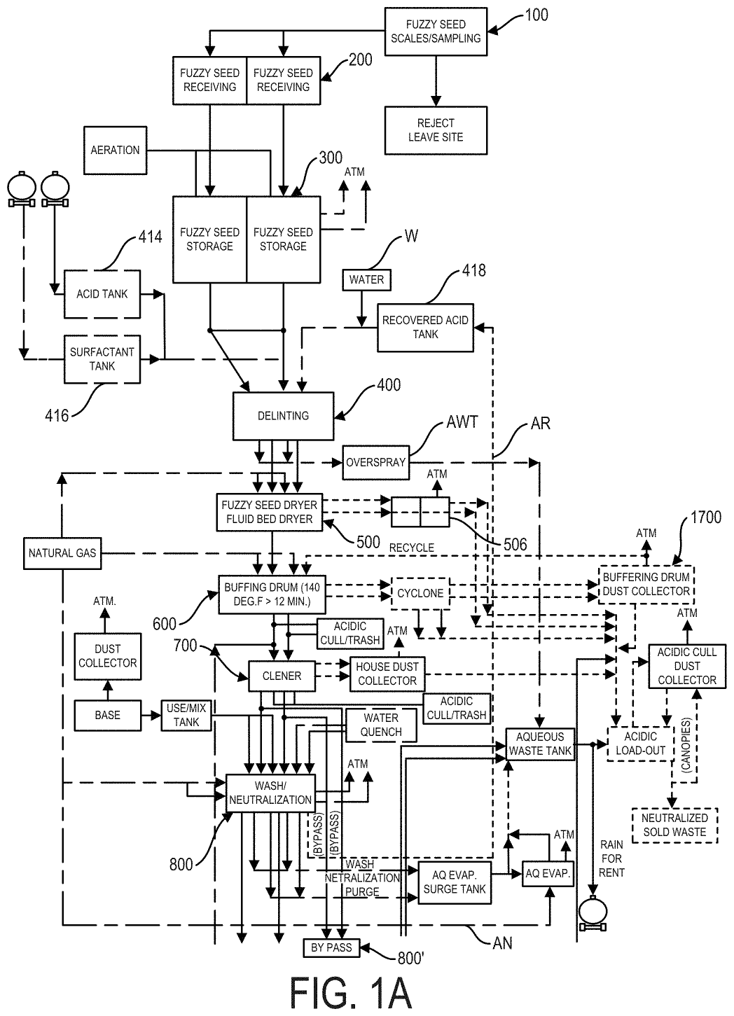

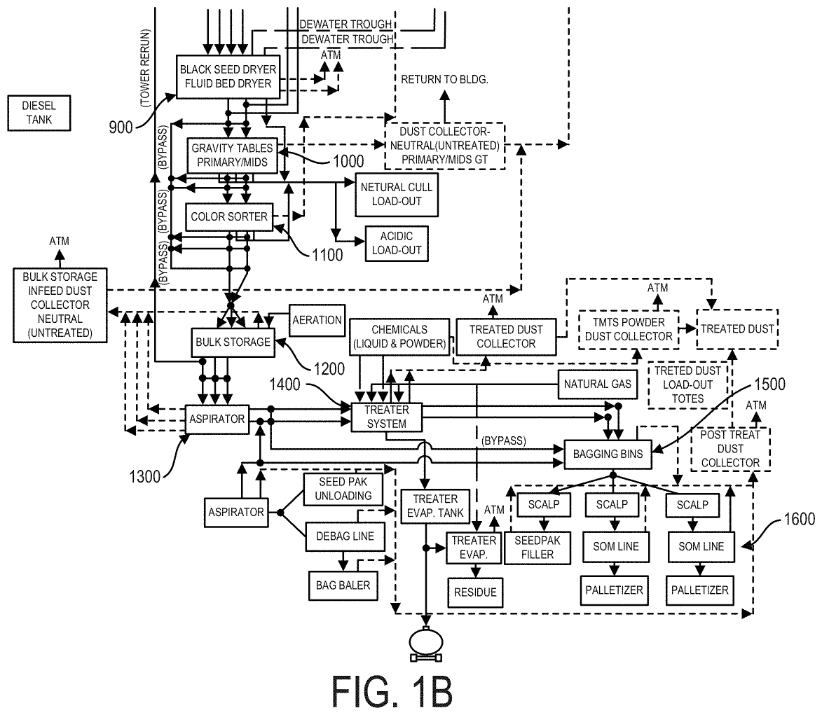

Referring to FIGS. 1A and 1B, a flow diagram of one embodiment of cottonseed processing includes representations of processing stations of a cottonseed processing plant. The illustrated processing stations include, but are not limited to: (i) fuzzy seed sampling/testing station 100; (ii) fuzzy seed receiving station 200; (iii) fuzzy seed storage station 300; (iv) acid application station 400; (v) fuzzy seed fluid bed dryer station 500; (vi) buffing drum station 600; (vii) seed cleaner station 700; (viii) seed wash/neutralization station 800; (ix) bypass station 800; (x) delinted seed fluid bed dryer station 900; (xi) gravity table station 1000; (xii) color sorting station 1100; (xiii) delinted seed bulk storage station 1200; (xiv) pre-treatment station 1300; (xv) seed treatment station 1400; (xvi) bagging bin station 1500; and (xvii) bagging/packaging station 1600. It is understood that the processing stations and the associated processes may be included at a single cottonseed processing plant or one or more of the stations and the associated processes may be included in more than one cottonseed processing plant. Moreover, the cottonseed processing may not include all of the stations and the associated processes and one or more of the stations and the associated processes may be of other embodiments and/or configurations.

In addition to these processing stations, the illustrated cottonseed processing plant includes a dust collection system 1700 and an acid recycling system 418, one or both of which may be omitted in one or more embodiments. The dust collection system 1700 includes one or more suction or cyclones and dust collectors for removing acidic dust at one or more of the stations, as shown in FIG. 1A. The dust may be collected in a waste bin for disposal or reuse. Components of the acid recycling system 418 are explained in more detail below when describing the delinting process. These components are also shown in FIG. 1A.

Cottonseed (e.g., fuzzy seed and black/delinted seed) is transported from station to station using one or more of belt conveyor(s), screw conveyor(s), bucket elevator(s), chute(s), aspirator(s), and/or other types of devices suitable for conveying cottonseed. Moreover, more than one dedicated line may connect the individual stations to increase throughput of seeds through the processing plant. In one example, more than one line is used, and the individual dedicated lines are independently controllable to adjust for suitable needs. For example, the processing plant may include more than one (e.g., three) dedicated receiving lines along which fuzzy cottonseed is transferred from the fuzzy seed receiving station 200 to the fuzzy seed storage station 300. For example, the processing plant may include more than one (e.g., three) individual dedicated delinting/analyzing lines along which cottonseed is transferred from the fuzzy seed storage station 300 through the color sorter station (1100). For example, the processing plant may include more than one (e.g., three) individual dedicated treatment lines along which cottonseed is transferred from the bulk storage station 1200 through the seed treater station (1400).

In addition, information relating to the different types of cottonseed (e.g., variety of cottonseed) is maintained throughout the processing processes. A control system, including one or more processors and one or more databases, tracks the cottonseed from the fuzzy seed sampling/testing station 100 through to the bagging/packaging station. For example, the type of cottonseed is determined at the fuzzy seed sampling/testing station 100 and associated with the trailer containing the certain cottonseed. The control system associates this cottonseed throughout the processing steps, including the line on which the cottonseed is transferred and the bins in which the cottonseed is stored.

### (i) Fuzzy Seed Sampling/Testing Station

Referring to FIG. 1A, the fuzzy seed sampling/testing station 100 includes a truck-receiving area (not shown) for receiving one or more trucks, at any given time, carrying fuzzy cottonseed in an attached trailer. The truck-receiving area may include a scale to weigh the amount of fuzzy cottonseed being carried in the trailer. In addition, information regarding the cottonseed in the trailer is retrieved. As an example, the information regarding the batch/lot (e.g., harvested locations) and/or variety of the cottonseed is retrieved. This may be provided by paperwork or a computer-readable tag associated with the trailer that is automatically read by a scanner at the truck-receiving area. At the truck-receiving area, a sampled quantity of cottonseed is collected from the received trailer and conveyed to a testing area of the fuzzy seed sampling/testing station 100. The testing area may be an enclosed area separate from the truck-receiving area. In one or more embodiments, the sampled seeds are aspirated from the trailer using an aspiration system. For example, an aspiration probe is placed in the trailer and a suction force conveys the quantity of sampled seeds through the probe, into a conduit, and to the testing area.

At the testing area, the sampled cottonseed is received and placed in a container. The container includes an ID (e.g., an RFID tag or other computer readable tag) that associates the sampled cottonseed in the container with the trailer from which the seed was sampled. In one example, the sampled cottonseed is delinted using a lab-scale delinting method. A suitable lab-scale delinting method is described in co-pending Non-Provisional application Ser. No. 16/584,374, filed Sep. 26, 2019, the entirety of which is hereby incorporated by reference herein. Other lab-scale delinting methods may be used. The sampled cottonseeds are tested using suitable methods to determine quality of the seed and/or variety of sampled cottonseeds. For example, the seeds may be analyzed using an X-ray imaging system, such as described in U.S. Non-Provisional application Ser. No. 16/271,005, filed Feb. 8, 2019, the entirety of which is hereby incorporated by reference herein. Based on the testing, the cottonseed in the trailer is accepted or rejected. If accepted, the truck is moved to the fuzzy seed receiving station 200 and the fuzzy seed contained therein is processed in the processing plant. If rejected, the fuzzy seed is not processed in the processing plant.

### (ii) Fuzzy Seed Receiving Station

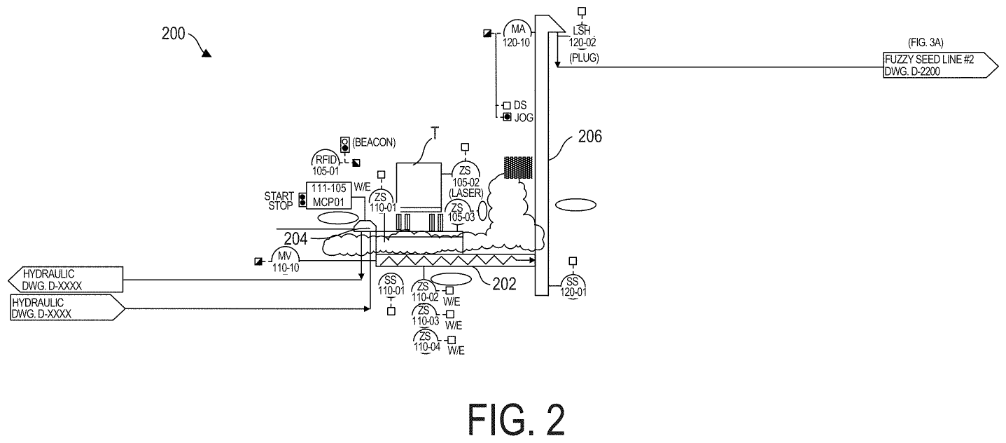

Referring to FIGS. 1A and 2, at the fuzzy seed receiving station 200, the trailer T with the accepted fuzzy seed (i.e., fuzzy cottonseed load) is scanned (e.g., the RFID tag is scanned) to identify the cottonseed (e.g., variety of cottonseed) in the trailer. The trailer unloads the fuzzy seed batch into a screw conveyor 202 or other seed transfer device. In one example, the fuzzy seed batch is loaded into the screw conveyor 202, from the trailer, through a dump door 204 (e.g., a hydraulic dump door) that is automatically controlled. In one example, the trailer T may have a walking floor, as generally known in the art, to unload the cottonseed batch into the screw conveyor 202 through the open dump door 204. The screw conveyor 202 transports the fuzzy cottonseed batch to a bucket elevator 206 or other seed transfer device. (Broadly, the screw conveyor and the bucket elevator may be considered a steep incline conveyor.) The bucket elevator 206 transfers the fuzzy cottonseed batch to the fuzzy seed storage station 300. In one or more embodiments, the bucket elevator 206 transfers the cottonseed batch to an elevated position within the fuzzy seed storage station 300, for reasons explained below. After unloading the entire cottonseed batch from the individual trailer T, the dump door 204 is closed and the trailer is removed from the receiving station 200. A new trailer T with a new batch of fuzzy cottonseed is not unloaded into the screw conveyor 202 until the prior fuzzy cottonseed batch is delivered and stored in the fuzzy seed storage station 300.

(iii) Fuzzy Seed Storage Station

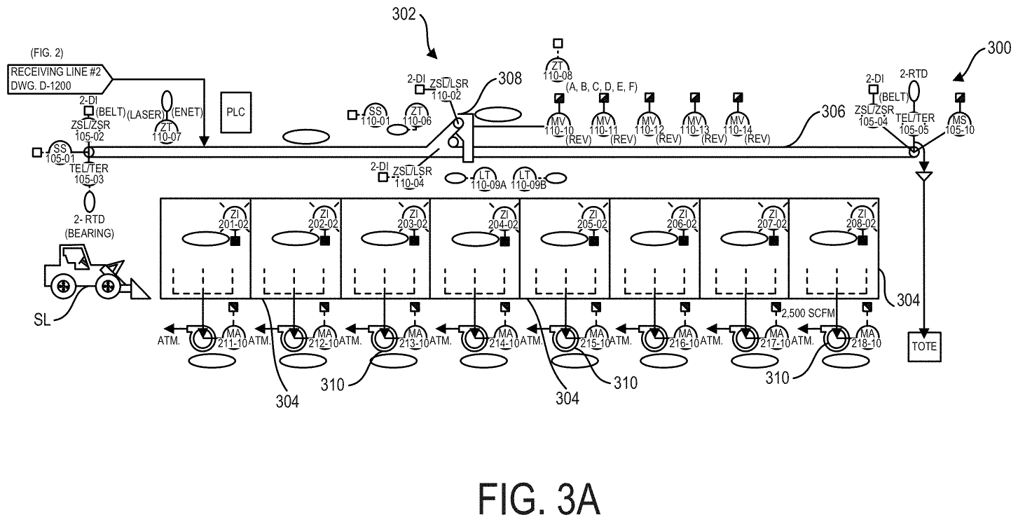

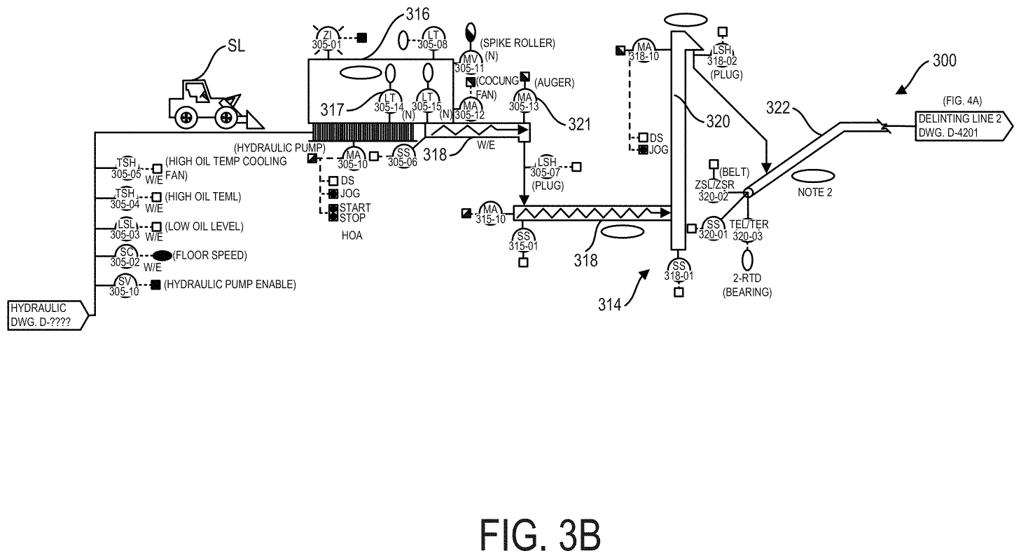

Referring to FIGS. 1A and 3A, the bucket elevator 206 delivers the fuzzy cottonseed to an elevated belt conveyor system 302 (e.g., conveyor belt tripper) or other seed transfer device of the fuzzy seed storage station 300. The seed information (e.g., variety) associated with the fuzzy cottonseed being transferred to the fuzzy seed storage station 300 is received by a PLC or other processor of the control system. The PLC or other processor controls the belt conveyor system 302 to deliver the fuzzy cottonseed batch to one of a plurality of individual storage bins 304 located below the belt conveyor system. In the illustrated embodiment, the belt conveyor system 302 includes a longitudinal belt 306 in communication with a tripper car 308 that moves longitudinally along the belt. The tripper car includes a diverter and a cross-wise belt conveyor controllable by the PLC or other processor for delivering the cottonseed into a selected one of the storage bins 304. In the illustrated embodiment, the fuzzy seed storage station 300 includes storage bins 304 on either side of the longitudinal conveyor 306. Cottonseed of the same variety will be delivered to the same storage bin 304 so as not to mix the variety of cottonseeds within the same storage bin. Moreover, the variety of cottonseed in each storage bin 304 is recorded in the database. In the illustrated embodiment, each storage bin 304 may include a dedicated aeration system 310.

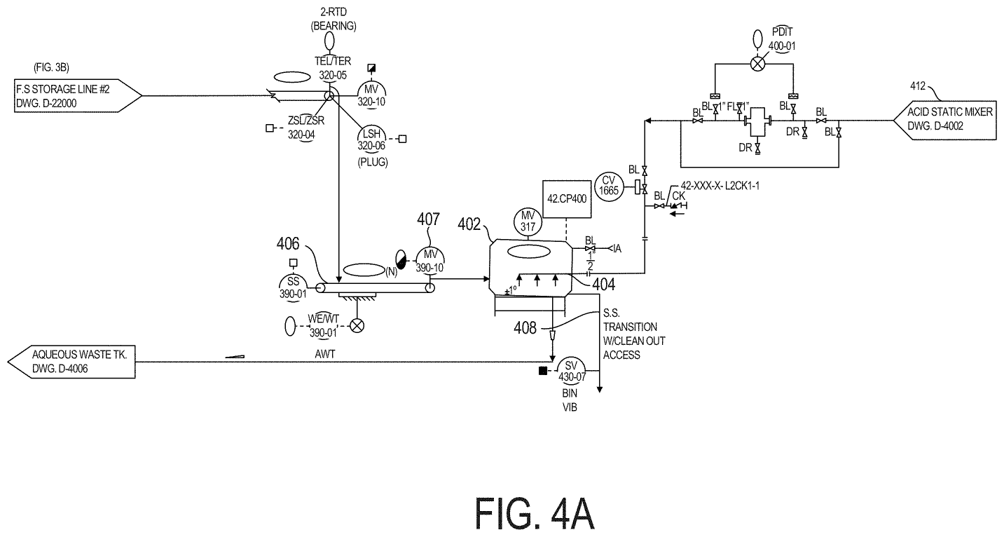

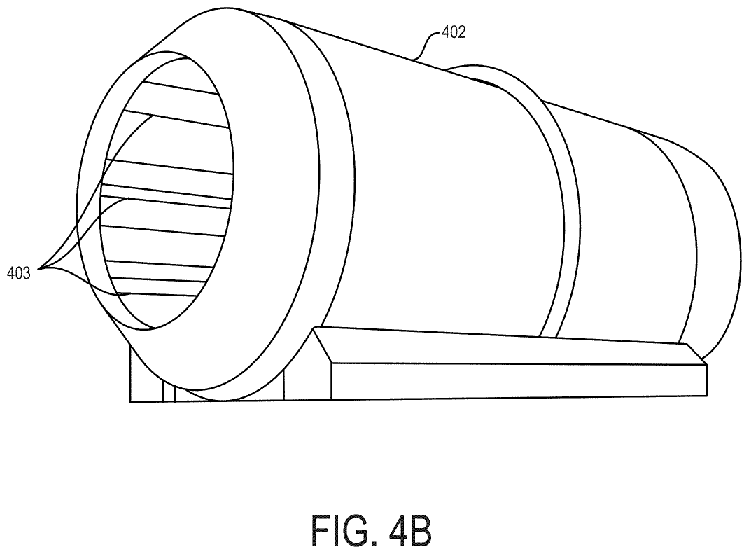

The fuzzy cottonseed is temporarily stored in the storage bins 304. Referring to FIG. 3B, from the storage bin 304, fuzzy cottonseed is delivered to a seed transfer system 314 that transfers the fuzzy cottonseed to the acid application station 400 (FIG. 4A). In one example, a skid loader SL or other device delivers stored fuzzy cottonseed from one of the storage bins 304 to a walking floor bin 316. Level transmitters 317 may be provided in the bin 316 and operatively connected to the control system to determine the level of seed in the bin. If the transmitters 317 detect a seed level below a predetermined threshold, the control system may signal to the operator that an error state may have occurred. For example, the control system may signal an alert to the operator to stop operation of the treatment process, prompt the operator to add more seed to the bin 316, or prompt the operator to verify whether the seed is being conveyed properly. The walking floor bin 316 delivers the fuzzy cottonseed to one or more screw conveyors 318. The screw conveyors transfer the fuzzy cottonseed to a bucket elevator 320. The screw conveyors 318 may be operated at variable speeds to control the rate at which the seed is delivered to the bucket elevator 320. For example, multi-variance motors 321 may be used to control the speed of the screw conveyors 318. The bucket elevator 320 conveys the fuzzy cottonseed to a belt conveyor 322 (e.g., inclined belt conveyor). The belt conveyor transfers the fuzzy cottonseed to the acid application station 400. In one example, there may be more than one dedicated line that transfers the fuzzy cottonseed to the acid application station 400. Each dedicated line moves the fuzzy cottonseed on the dedicated line through the processing steps, before the bulk storage station 1200, without mixing the seeds on the dedicated lines. In this way, the variety (and possibly other information) of the cottonseed on each line is known throughout the processing steps and in the bulk storage bins.

### (iv) Acid Application Station

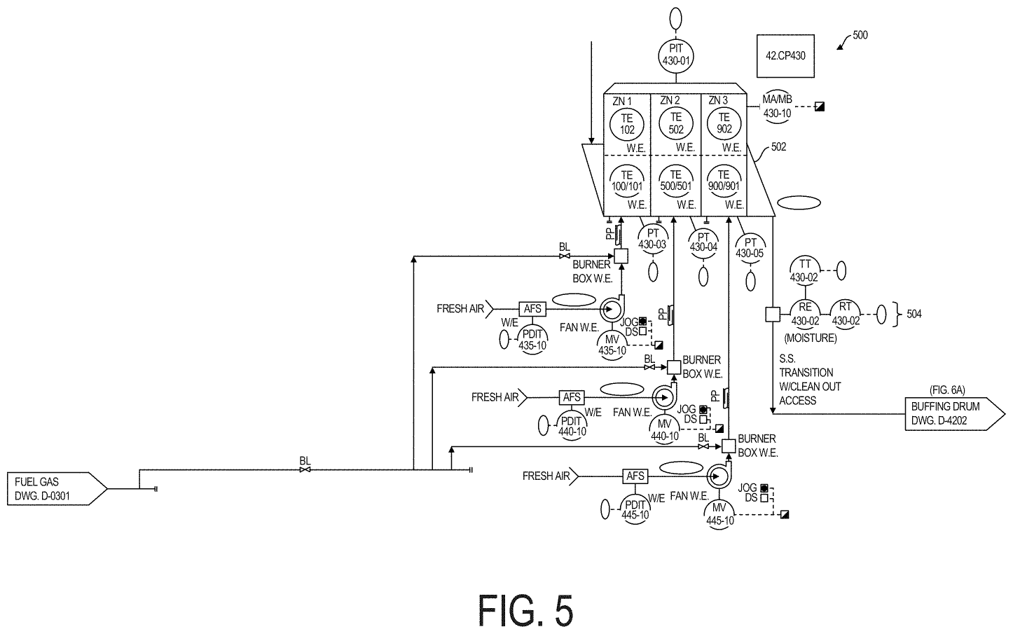

Referring to FIGS. 1A, 4A and 4B, the acid application station 400 includes one or more rotatable horizontal drums 402 (broadly, an acid application device) for applying an aqueous acid (e.g., diluted acid; acid solution of acid and a surfactant) to the fuzzy cottonseed. The horizontal drum 402 includes internal baffles 403 or ridges on an interior surface of the drum and extending along the length of the drum. In one example, the internal baffles 403 may have triangular shaped cross sections. The horizontal drum 402 may be angled slightly relative to horizontal (e.g., sloped 1 degree) to facilitate movement of the cottonseeds from an inlet longitudinal end to an outlet longitudinal end opposite the inlet longitudinal end. The angle or pitch of the horizontal drum 402 may also be adjusted. For instance, adjusting the angle of the drum 402 allows a residence time (i.e., amount of time the cottonseeds remain in the drum) to be selected by the operator. In particular, the steeper the angle the faster the cottonseeds will travel through the drum 402 and therefore producing a shorter residence time. As described above, more than one line may be used to transfer the cottonseeds to the acid application station 400. In such an embodiment, that acid application station includes the same number of rotatable horizontal drums 402 as the number of lines (e.g., three). A spray bar 404 within the horizontal drum 402 delivers (e.g., sprays) the acid solution onto the seeds as the horizontal drum rotates about a horizontal axis. The fuzzy cottonseed tumbles or cascades within the rotating horizontal drum 402 to effectively coat and cover the lint on the fuzzy cottonseed. The internal baffles 403 facilitate even coating of the fuzzy cottonseed with acid. Before entering the drum 402, the fuzzy cottonseed may be weighed (such as on an input conveyor 406). The input conveyor 406 may be operated at variable speeds to control the rate at which the seed is delivered to the drum 402. For example, a multi-variance motor 407 may be used to control the speed of the input conveyor 406. The weight of the fuzzy cottonseed entering the drum 402 may be used by the control system to determine the amount of acid solution (e.g., including sulfuric acid and a surfactant) applied to the fuzzy cottonseeds within the drum. The control system controls the amount of acid solution applied. The wetted fuzzy seed exits the rotating horizontal drum 402 through an opening in the drum at the outlet longitudinal end, and is delivered to the fuzzy seed fluid bed dryer station 500 (FIG. 5), such as by a vertical chute 408. In one embodiment, overspray can be collected in the aqueous waste tank (FIG. 1A) and then applied to the acidic linters to neutralize the acidic cull waste prior to leaving the site.

In one example, the acid solution is mixed within a mixer 412 before being delivered to the horizontal drum 402. In one embodiment, three different sources of material are combined to make the acid solution in the mixer. As shown in FIG. 1A, the three sources include a source of concentrated sulfuric acid 414 (or other acid, such as hydrochloric acid, and/or methanesulfonic acid), a source of a surfactant 416, and a source of recycled acid 418 acquired from the wash/neutralization station, as explained in more detail below. The recycled acid source 418 may deliver a recycled acid solution that contains a large percentage of water. However, the recycled acid solution can also be diluted using a water source W (FIG. 1A). In the embodiment with independent lines, the on-demand direct inject acid dilution system (water/recovered acid, concentrated sulfuric acid and surfactant) will allow for each of the delinting lines to operate using different formulations (e.g., ranging from about 4% to about 12% sulfuric acid) at a rate of about 70 to about 120 gallon of solution/ton of fuzzy seed. In one embodiment, the system operates using about 4% to about 6% sulfuric acid at a rate of up to about 110 to about 120 gal/ton. It has been found that seed quality can be maintained at these operating parameters. All chemicals will be added individually using inline static mixers to create a homogenous solution. As such, the lines can operate with different concentrations and flow rates.

### (v) Fuzzy Seed Fluid Bed Dryer (FS-FBD) Station

The fuzzy seed fluid bed dryer (FS-FBD) station 500 receives the wetted fuzzy cottonseed from the horizontal drum 402, such as from the vertical chute 408 that delivers the wetted fuzzy cottonseed by gravity. The FS-FBD station 500 includes one or more fluid bed dryers 502, again depending on the number of dedicated lines for the fuzzy cottonseed. The fluid bed dryer 502 applies heated air in three (3) separate controllable zones in order to evaporate external liquid from the (normal) 10% sulfuric acid application on the fuzzy cotton seed prior to buffing. Application of heated air is applied to evaporate water to reduce the external moisture content on the seed from inlet to discharge by >15%, for example. In one example, the external moisture on the cottonseed will be dropped from incoming of about 21% external moisture to exiting at about 7% external moisture. A moisture sensor 504 detects the moisture of the fuzzy seed exiting the fluid bed dryer 502. This data is inputted to the control system as feedback to adjust one or more parameters of the acid application station 400 and/or the FS-FBD station 500 if the moisture is not within an acceptable range. As shown in FIG. 1A, the fluid bed dryer 502 is connected to a cyclone 506 for collecting dust with product being sent down the line to be processed.

The heated air is forced through a drilled deck designed for fluidizing the seed bed. Amplitude and angle of vibration are adjustable to allow for changes in residence time as needed. The fluid bed dryer 502 has adjustable heat to reach a variety of ranges as the seed passes across the machine. The air temperature is controlled with redundant thermocouples both in the air stream and within the seed bed itself. In the illustrated embodiment, the system is designed with the three (3) individual controlling zones in order to maintain the optimum setpoints with reduced risk of subjecting the seed to elevated temperature. The fluidizing air is supplied to each dryer 502 via a dedicated supply fan. Flow to each of the three (3) drying zones is adjustable through variable speed drives. Each drying zone will have a dedicated, natural gas-fired air heater with temperature control, for example. The material temperature will be a controlling factor and will be measured at the end of each zone. The supply air temperature will be controlled based on material temperature. Normal supply air temperatures will range from approximately 150° F. (65° C.) to approximately 300° F. (149° C.) during a normal operation which may be approximately 3 minutes. Seed temperature will range from about 110° F. (43° C.) to about 145° F. (63° C.) so as not to damage the seeds. The prior art seed dryer uses a rotary drum tumbled with hot air, which may be more likely to damage the cottonseed. For example, the air temperature may reach 800° F. in conventional processes which may damage the seeds.

### (vi) Buffing Drum Station

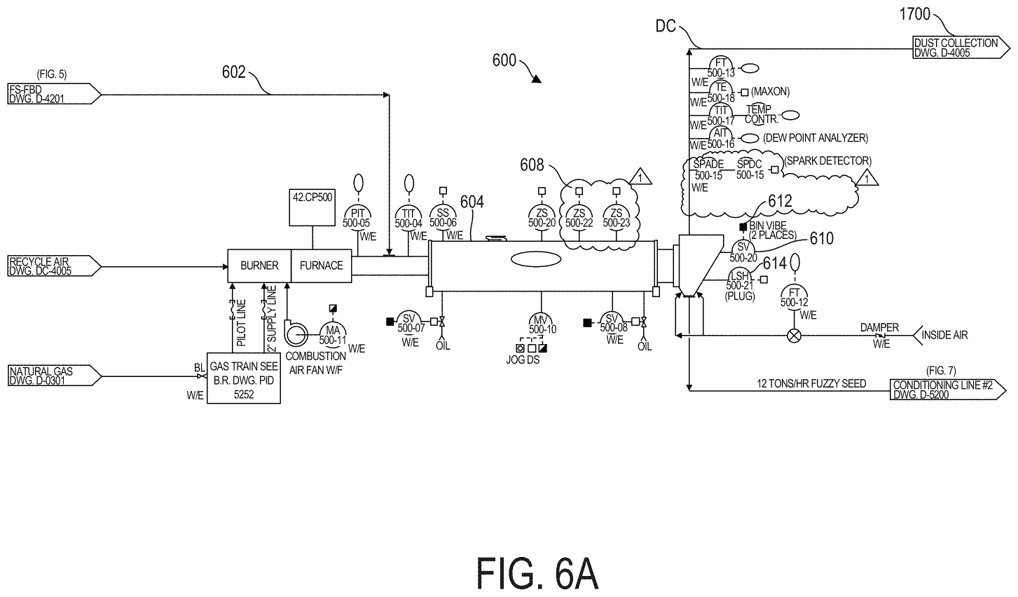

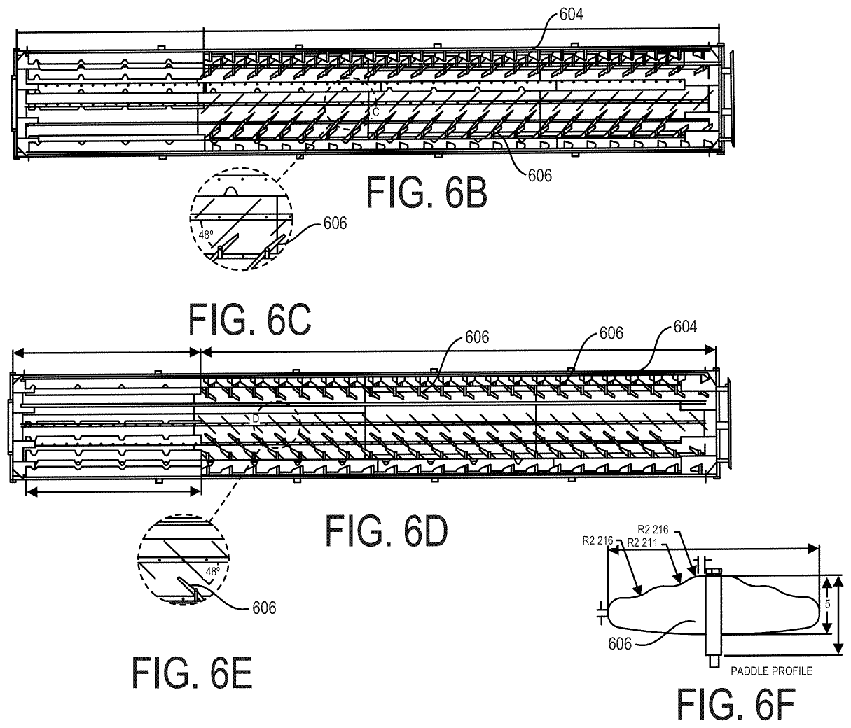

Referring to FIGS. 6A-6F, the buffing drum station 600 receives the fuzzy cottonseed from the FS-FBD station 500 via a vertical chute or other transfer device 602. The buffing drum station 600 includes a rotatable, horizontal buffing drum 604 including internal agitation paddles 606 for buffing the cottonseeds. Heated air is supplied to the buffing drum to reduce the external moisture content of the cottonseed from inlet to discharge by approximately 10% and buffing (e.g., seed-to-seed contact) to remove the acidic lint (i.e., linters; cellulose fibers) on the fuzzy cottonseeds. Heated air induces a chemical reaction between cellulose and acid resulting in the cellulose linters hydrolyzing and becoming brittle. The acidic cellulose fibers (i.e., linters) are pneumatically conveyed to a dust collection system 1700, as shown by line DC. Once the cellulose laden air passes through the dust collection system, a portion of the heated air is recycled back through the system, instead of being released into the atmosphere, to conserve energy and prevent waste. The internal surface and agitation paddles 606 impart seed-to-seed contact and movement of seed inside the buffing drum 604. In one example, the orientations of agitation paddles 606 are adjustable. That is, the angles at which the paddles 606 extend relative to the longitudinal axis of the buffing drum 604 may be adjustable. In this way, the speed at which the seed moves or flows longitudinally through the buffing drum 604 is adjustable by adjusting the angles at which the paddles 606 extend. For example, angling the paddles 606 to extend at a more vertical angle will cause the seed to travel slowly through the drum 604 while angling the paddles to extend more horizontal will cause the seed to travel more quickly through the drum. Slowing the speed or flow of the seed will increase the time (and thus the seed-to-seed contact) within the buffing drum 604. The internal contact surfaces of the drum 604 may be made of stainless steel. Additionally, position switches 608 on the drum 604 may be configured to orient the drum such that entry doors may be accessible so that an operator can access the interior of the drum. Also, a level switch 614 may be used to signal if the seed begins to clump which impedes the seed flow. If the level switch 614 indicates the seed level building up in the exit vestibule, a vibratory mechanism 610 may be activated to vibrate the vestibule to aid in restoring the desired seed flow. If the flow switch 614 detects a plugged position, seed flow will be discontinued allowing the drum to clear if possible. Additionally or alternatively, vibratory mechanisms can be activated to vibrate the drum 604 to restore seed flow in the drum.

(vii) Seed Cleaner Station

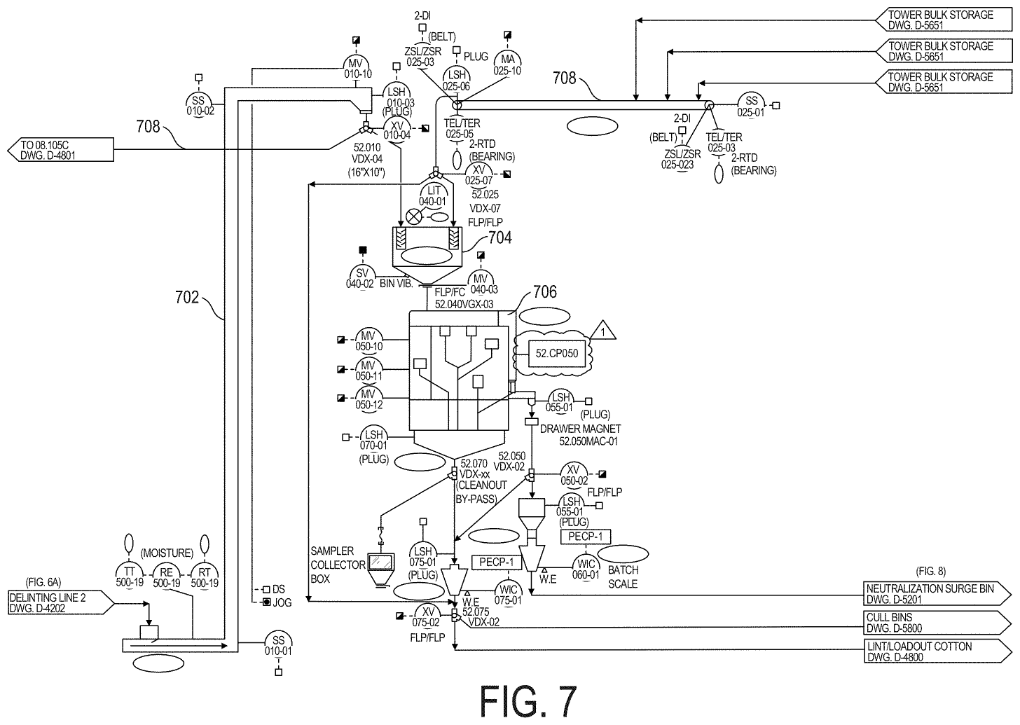

After the buffing drum 604, the delinted seed is transferred to the seed cleaner station 700 (FIG. 7), via a bucket elevator 702, for example. The delinted seed is transferred to a surge collector 704, and then through an air screen cleaner 706 designed for scalping and fines trash removal. Forced air along with an eccentric screen movement provide density separation. A suitable air screen cleaner is generally known in the art. Alternatively, seed may be diverted away from the surge collector 704 to waste or cull collection at 708.

(viii) Seed Wash/Neutralization Station

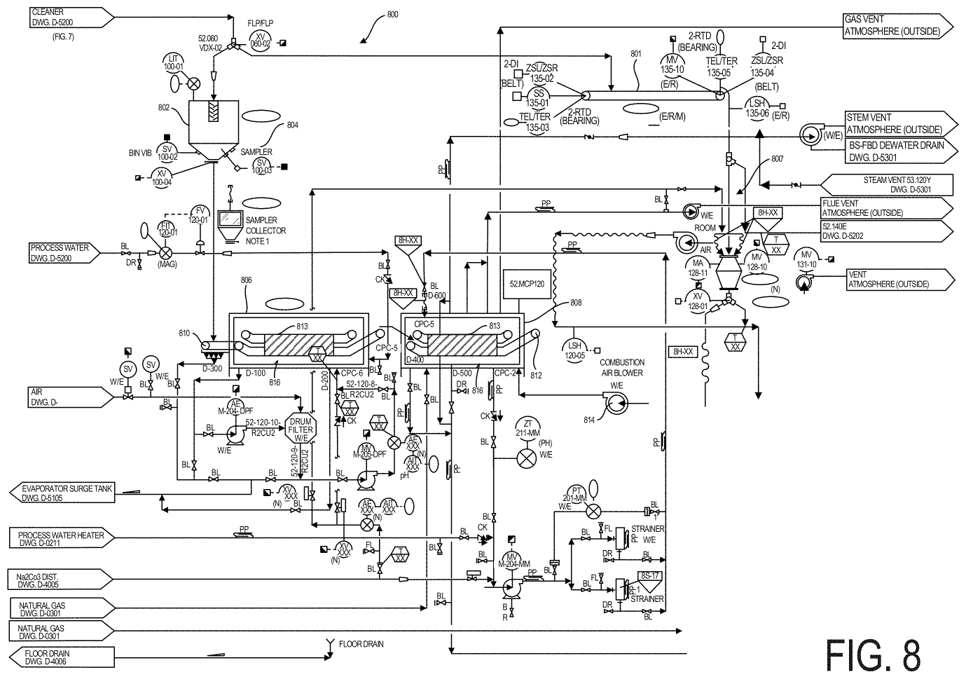

Referring to FIGS. 1A and 8, from the seed cleaner station 700, the delinted seed is transferred to a neutralization surge bin 802 of the seed wash/neutralization station 800. A sample of delinted seeds may be taken from the surge bin 802 at a sampler 804 to determine the effectiveness of the delinting process and/or the amount of acidic residue remaining on the delinted seeds. The delinted seeds are then passed through one or more baths 806, 808 (e.g., two or more baths in series) on a conveyor 810, 812, respectively. In the illustrated embodiment, each conveyor includes upper and lower conveyor belts that pinch the seeds therebetween to move the seeds through the baths 806, 808. The upper and lower conveyor belts ensure that the seeds are submerged in the liquid in the baths 806, 808. The conveyors 810, 812 may include side guarding 813 to prevent seed loss from seeds falling off the sides of the conveyors. The conveyors 810, 812 may be driven by any suitable means. For example, the conveyors 810, 812 may be a slave driven pin roll belt drive system or a slave driven chain and sprocket drive system. The slave driven chain and sprocket drive system may be advantageous in eliminating the seed from being caught in the pin roller which can lead to belt breakage. Having a side guarding 813 on the conveyors 810, 812 can also prevent mechanical damage to any pin roller pulleys and help to eliminate belt breakage. In another example, the seed wash/neutralization station 800 may include a corkscrew type conveyor (not shown), or other type of conveyor, within the baths 806, 808 in place of the upper and lower conveyor belts 810, 812. The corkscrew type conveyor would also provide submersion of the seeds in a bath of liquid. The conveyors may be broadly considered transporters. Accordingly, other mechanisms for delivering the cottonseed through the baths 806, 808 may be used without departing from the scope of the disclosure.

In one embodiment, the station 800 includes a series of baths: one of which includes water for washing the seeds and recovering residual acid that is recycled back to the acid application station 400, and the other includes a basic solution (e.g., sodium carbonate) for neutralizing the residual acid on the delinted seeds. In another embodiment, each of the series of baths may include one of water or basic solution. Other functions for the one or more baths are possible. In one example, at least one of the baths 806, 808 (e.g., the last bath in a series) is configured to optionally heat the liquid (e.g., by heated air 814). This functions to break the dormancy of “hard seed,” and may be selectively employed when desired. For example, the liquid (e.g., water) may be heated to about 185° F. It is also contemplated that in one or more embodiments, the heated bath may be located immediately upstream of the buffing drum station 600, immediately downstream of the buffing drum station, or in other locations after delinting the hard seeds. The bath including the basic solution may be broadly considered a neutralization device.

Additionally or alternatively, sediment conveyors 816 may be included on the bottom of each conveyor pan to reduce solids buildup in the pans. The sediment conveyors 816 may carry the sediment to carts having valved drains so that the solids can be washed through the drains to totes for responsible removal from the site. This has the benefit of reducing hydraulic waste and expense of the process. Additionally, rather than continuously overflowing water to the drain, the water level can be controlled in the wash conveyor pan to reduce waste and expense. In one embodiment, capacitive proximity sensors (not shown) may be utilized to shut off the flow of water. Additionally, a drum filter (not shown) may be used on the wash pans to further reduce solids buildup in the wash water.

As shown in FIG. 1A, the acid-water from the respective bath may be recovered and transferred to the source of recovered acid via line AR. Alternatively, the acid-water may be sent to a waste collection. The acid-neutralization is purged from the respective bath via line AN to a surge tank, evaporator and aqueous waste tank.

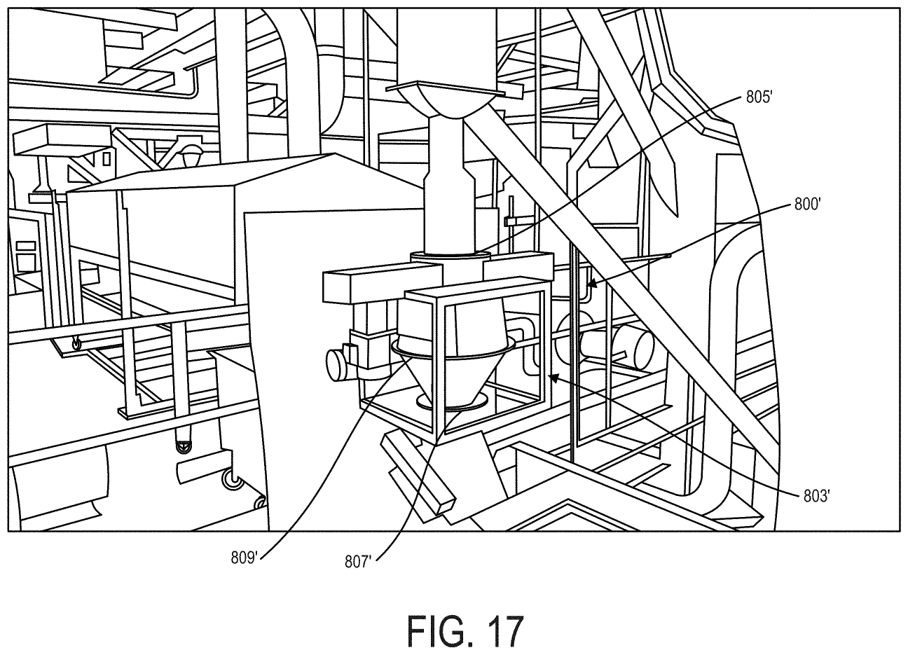

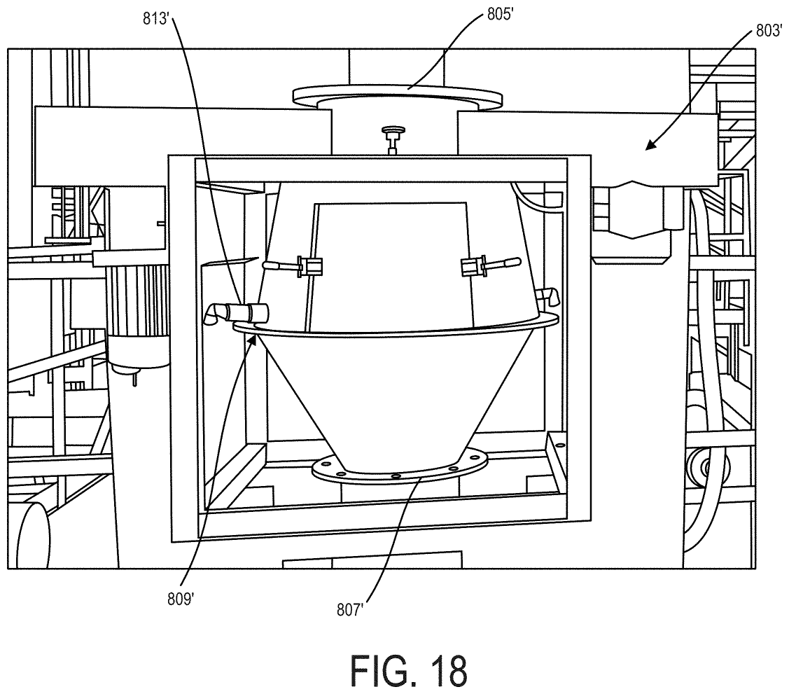

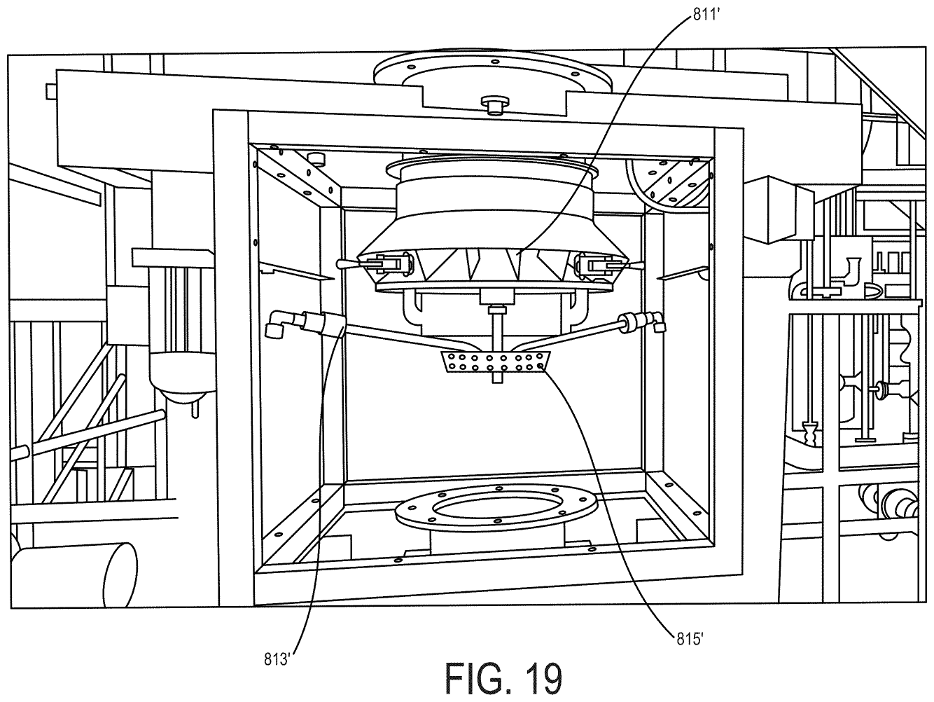

Alternatively, the seed wash/neutralization station 800 may be bypassed such that the seeds are delivered from the seed cleaner station 700 around the seed wash/neutralization station 800 to the delinted seed fluid bed dryer station 900 or to another station downstream of the fluid bed dryer station. For example, the seed wash/neutralization station 800 may be bypassed when it is not desired to soak the seeds in a hot water bath and/or when there is no requirement to break dormancy. Bypassing the wash/neutralization station 800 may also provide the benefit of reducing the liquid load on the system and alleviating a potential bottleneck of the process. During the bypass step, however, the seeds can still be processed in a seed neutralization step. Referring to FIGS. 8 and 17-19, a conveyor 801 may direct the seeds from the seed cleaner station 700 to a bypass station 800′. The bypass station 800′ may comprise a seed neutralization device 803′ for neutralizing the seeds. The neutralization device 803′ includes a treater body 809′ having an inlet 805′ for receiving the seeds from the conveyor 801, and an outlet 807′ for delivering the neutralized seeds to the seed fluid bed dryer station 900 or some other downstream station. The treater body 809′ includes a rotary weldment 811′ that rotates within the treater body and causes the seeds to separate into an evenly distributed thin dome layer. In one embodiment, the rotary weldment is configured to spin at a relatively low RPM. A neutralization solution (i.e., a base solution) is delivered (i.e., sprayed) through a tube 813′ into the treater body 809′ at a predetermined rate. A mist disc 815′ (broadly, an atomizer) in the treater body 809′ causes the atomization and dispersion of the neutralization solution. The mist disc 815′ in the treater body 809′ produces an even distribution of the neutralization solution so that the dome layer of seed is uniformly coated by the solution. The seeds follow a continuous flow path within the treater body 809′ and exit the rotary device at the outlet 807′. The seeds may then be routed to the seed fluid bed dryer station 900 or alternatively transferred to a high temperature water bath station to break dormancy if needed. The neutralization solution is then sent to a waste collection. An operator will be able to select, via the control system, into which neutralization process (i.e., seed wash/neutralization station 800 or bypass station 800′) the seeds are diverted. For example, the variety of the seed may determine to which station the seeds are diverted. However, any number of factors may determine which station is used.

### (ix) Delinted Seed Fluid Bed Dryer Station

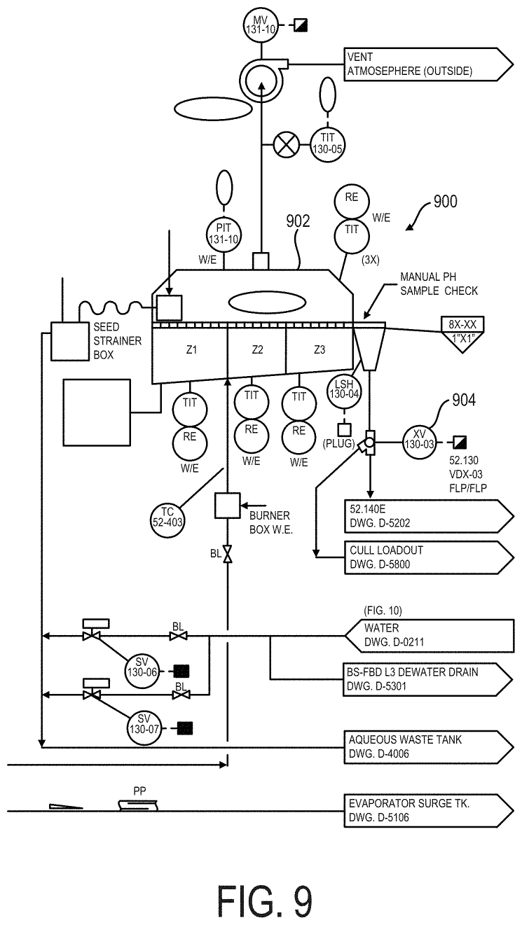

Referring to FIGS. 1B and 9, after washing/neutralizing the delinted (or black) cottonseeds, the cottonseeds are dried, such as by a fluid bed dryer 902 at the delinted seed fluid bed dryer station. The fluid bed brings the cottonseed to a 0% (+/−0.5%) external moisture. The fluid bed dryer may be of a similar type and construction as the fuzzy seed fluid bed dryer 500. In another embodiment, the fluid bed dryer 902 may be a single temperature zone and single air flow zone. Other types of dryers may be used at this station. A moisture sensor 904 detects the moisture of the delinted cottonseed exiting the fluid bed dryer 902 to provide feedback to selectively adjust parameters of one or more of the bath(s) and the fluid bed dryer so that the cottonseeds are within an acceptable range of moisture. The pH of the exiting seeds may also be checked after exiting the fluid bed dryer 902. In a conventional process the seeds may not be actively dried or dried in a dryer drum that may damage the seeds.

### (x) Gravity Table Station

After drying, the delinted seeds are analyzed or tested to ensure quality for planting. The following stations, including the gravity table station 1000 and the color sorting station 1100, are exemplary. It is contemplated that the processing plant may have other stations for performing other analyses/tests to ensure the quality of the seeds.

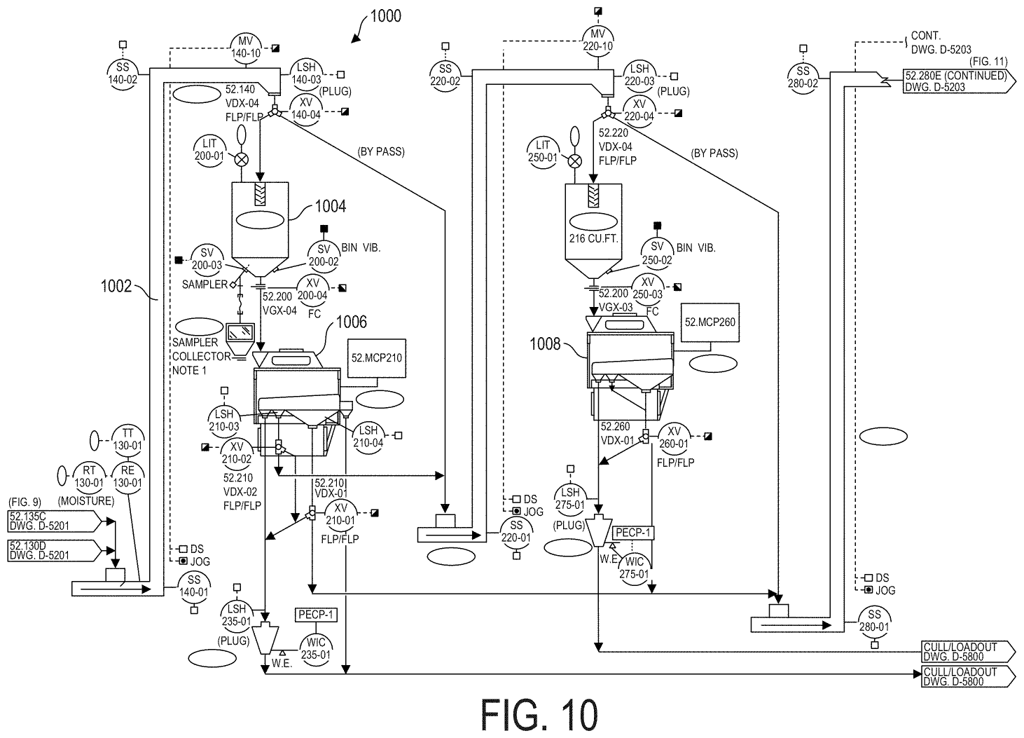

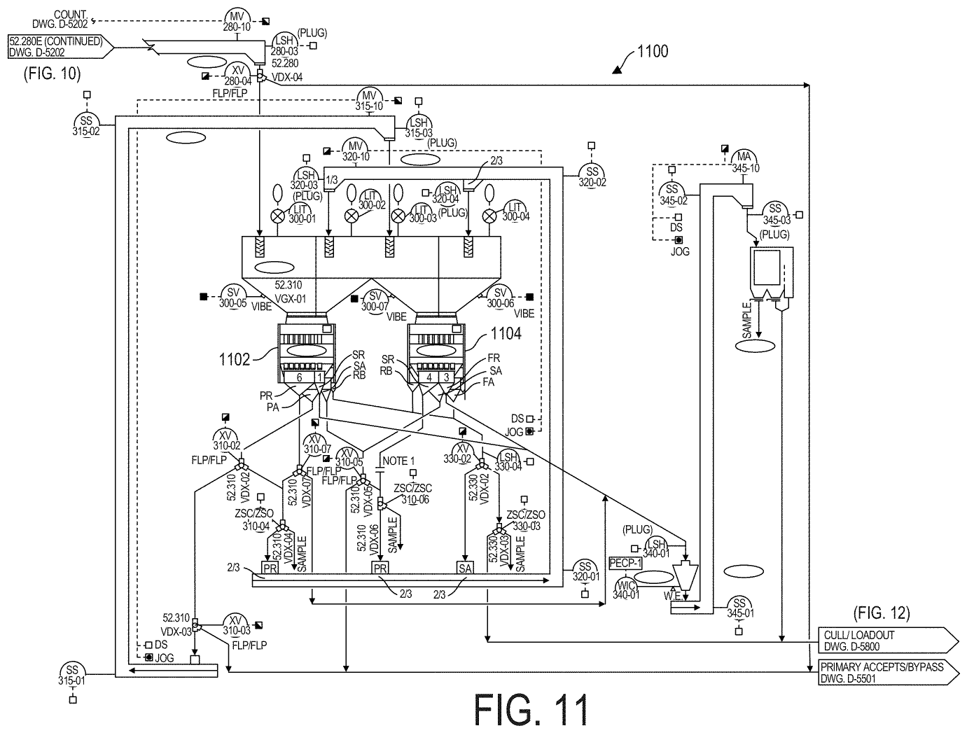

Referring to FIGS. 1B and 10, the cottonseeds are transferred to a cup elevator 1002 or other transfer system of the gravity table station 1000. The cup elevator 1002 transfers the seeds to a surge bin 1004, where a sample of the seeds can be taken. From the surge bin, the seeds are delivered to at least one gravity table 1006, 1008 to separate the seeds based on density. If a seed has an insufficient density, the seed will be sorted out into a reject bin. Seeds sorted to a reject bin are run an additional time to ensure insufficient density. If the first-time rejected seeds are rejected a second time, they are sent to waste or cull collection. In the illustrated embodiment, the gravity table station 1000 includes more than one gravity table: a primary gravity table 1006 and a mid-gravity table 1008. It is understood that other types of devices for testing the density of the delinted seeds may be used in place of the gravity table station 1000.

### (xi) Color Sorting Station

Referring to FIGS. 1B and 11, in one example, after the delinted seeds pass the gravity table station 1000, the seeds are transferred, such as by a cup elevator, to the color sorting station 1100. In one embodiment, the color sorting station analyzes the seeds to determine if the seeds are damaged, and therefore, not of suitable quality. In one example, the color sorting station 1100 includes an NIR (near infrared) analyzer 1102, 1104 (or other type of color analyzer) that is configured to detect two different shades of white on the cottonseed: a first shade indicating residual lint on the seed, and a second shade indicating an embryo of the cottonseed. If the shade of white indicating the embryo of the seed is detected, it is indicative of the cottonseed being damage, and the seed is removed from the line (i.e., seed is rejected). The rejected seeds are run a second time through the NIR analyzer 1102, 1104, and if the shade of white indicating the embryo of the seed is detected, the seed is removed from the line (i.e., seed is rejected) and transferred to neutral cull load-out via a conveyor.

(xii) Bulk Storage Station

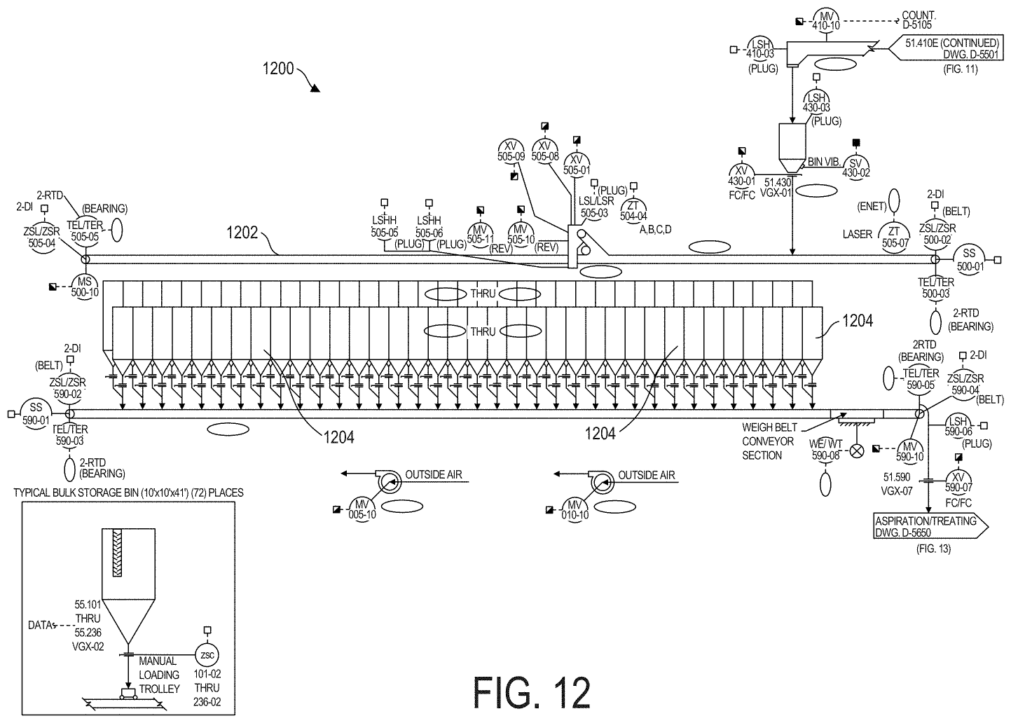

Referring to FIGS. 1B and 12, after passing the analyzing stations and being accepted, the cottonseeds on the dedicated line are transferred to the bulk storage station 1200, such as via cup elevators and belt conveyor(s). The bulk storage station 1200 includes a tripper belt conveyor 1202 and a plurality of storage bins 1204 below the tripper belt conveyor. The control system controls the tripper belt conveyor to deliver the delinted and analyzed cottonseeds into a selected and desired storage bin. As described above, cottonseed that was delinted and then analyzed is “tracked” throughout both processes such that the identification of the cottonseed (e.g., variety, etc.) is included in the database of the control system of the processing plant. The control system records in the database the storage bin 1204 that the batch of delinted and analyzed cottonseed is stored. Accordingly, information regarding cottonseed in each of the storage bins is “known.” The cottonseed can remain in the bulk storage station 1200 for an extended period of time before being further processed. Thus, the cottonseed in the bulk storage station 1200 is available for “on-demand” treatment and packaging, as described below.

(xiii) Pre-Treatment Station

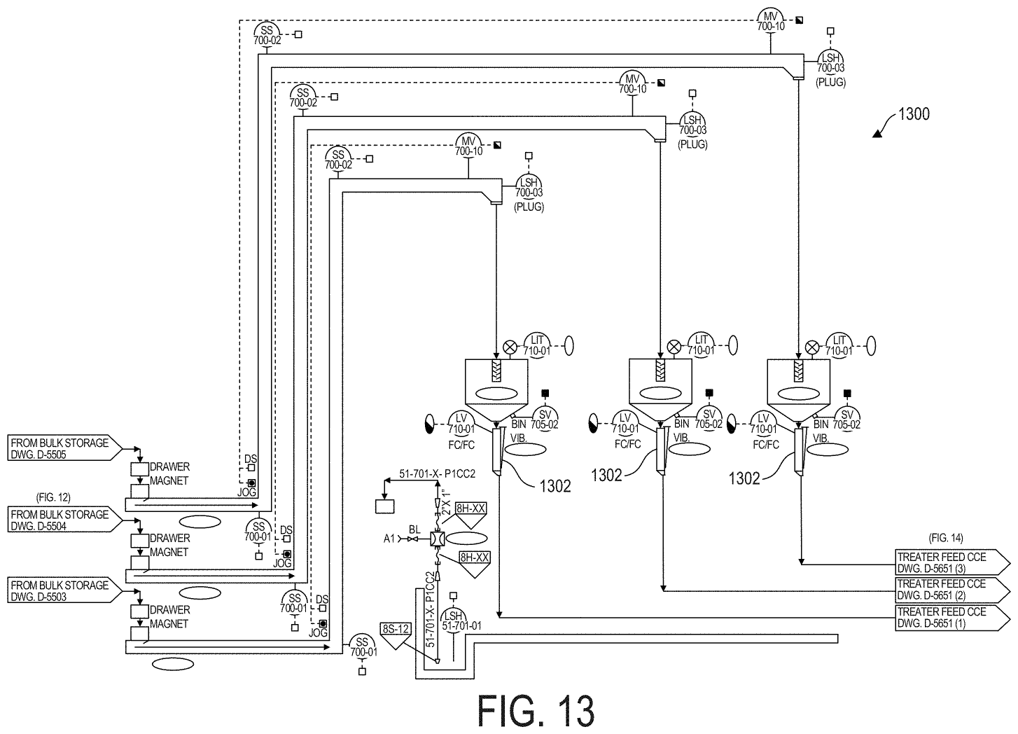

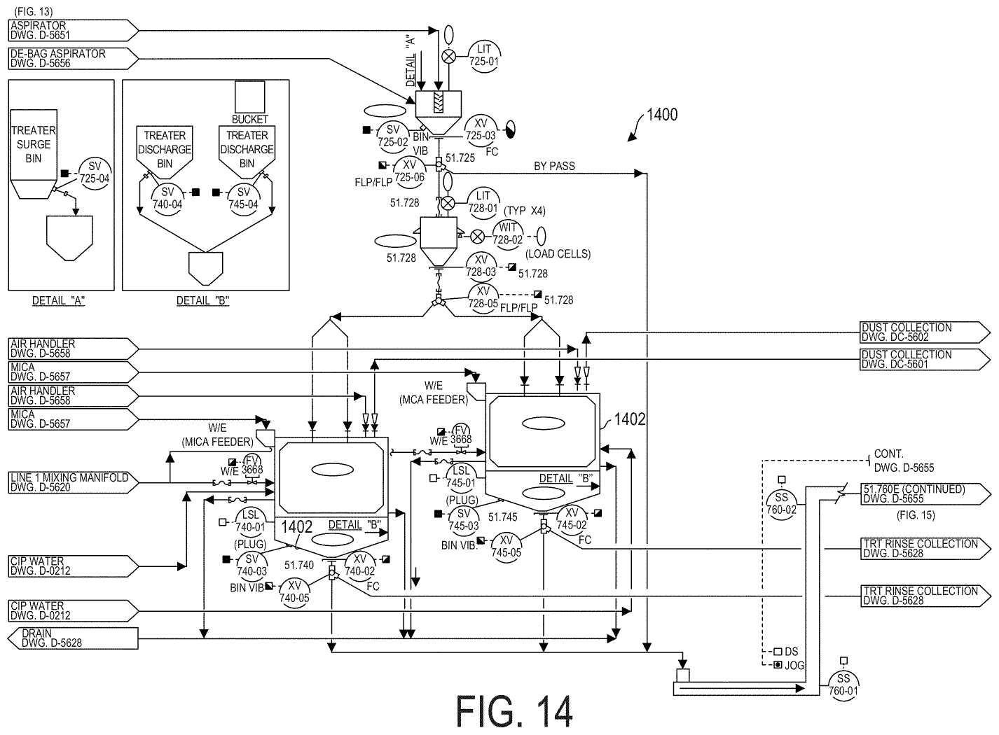

Referring to FIGS. 1B and 13, from the bulk storage station 1200, a quantity or batch of delinted seed is transferred from the selected bulk storage bin to the pre-treatment station 1300, such as via a trolley on a belt conveyor (as shown in FIG. 12) on a dedicated treatment line. The batch of delinted seed remains on the dedicated treatment line until transfer to the bagging/packaging station 1600. In the illustrated embodiment, the pre-treatment station 1300 includes one or more aspirators 1302 (e.g., three aspirators) dedicated to a respective one of the dedicated treatment lines. The aspirator 1302 is configured to reduce and/or eliminate any fines remaining in the batch of cottonseed to be treated.

(xiv) Seed Treatment Station

Referring to FIGS. 1B and 14, after pre-treating, the delinted cottonseed is transferred to the seed treatment station 1400, such as via a belt conveyor, on the dedicated treatment line. The seed treatment station includes one or more seed treaters 1402 (e.g., two seed treaters), dedicated to a respective one of the dedicated treatment lines, configured to apply a selected seed treatment on the delinted cottonseeds. An exemplary seed treater that is suitable for the seed treatment station is described in International Application No. PCT/US2018/040170, filed Jun. 29, 2018, the entirety of which is hereby incorporated by reference herein. Briefly, as described in the seed treater in the application, the seed treater is configured to apply both liquid seed treatment via a liquid spray bar and powder seed treatment via a powder spray bar to a batch of cottonseed. The liquid seed treatment and the powder seed treatment are delivered to the seed treater from a remote storage/mixing location in the processing plant via a system of conduits. The remote storage/mixing location provides on-demand seed treatment for the seed treater based on the desired treatment recipe to be applied to a selected batch of cottonseed.

### (xv) Bagging Bin Station

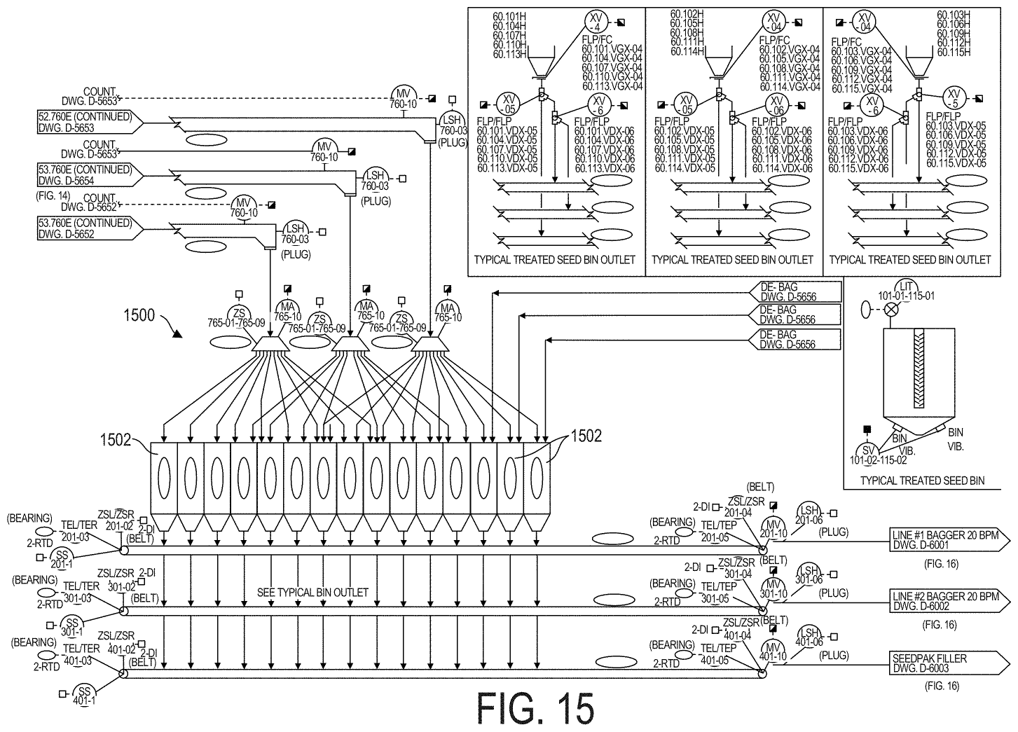

Referring to FIGS. 1B and 15, When treatment is completed, the treated cottonseeds exit the seed treater and are transferred to the bagging bin station 1500, such as via a chute or other seed transfer mechanism. The bagging bin station 1500 includes a plurality of bagging bins 1502, which, in one example, has a capacity of 337.5 tons of treated seed for either treated seed or rebagging. The bins 1502 can filled via distributors and gravity flow into any combination of bins. The treated cottonseeds in the bagging bins 1502 are ready for bagging/packaging at the bagging/packaging station 1600.

(xvi) Bagging/Packaging Station

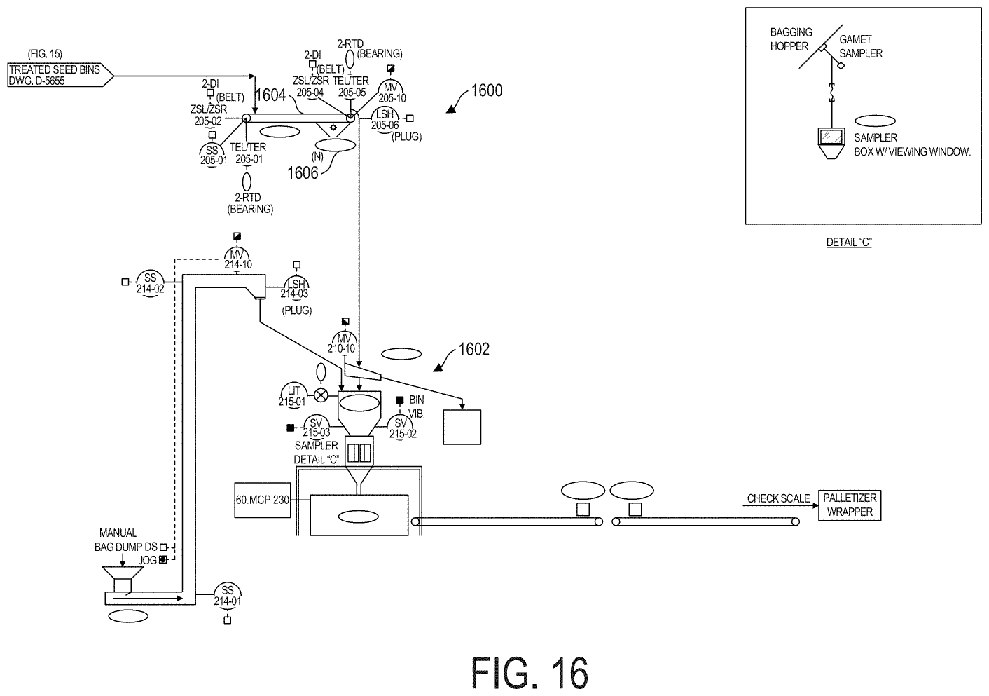

Referring to FIGS. 1B and 16, the seeds in the bins 1502 are selectively bagged/packaged and optionally palletized at the bagging/packaging station 1600. The bagging/packaging system includes a bagging machine 1602 and optionally a palletizer. A bagging conveyor 1604 delivers the seed to the bagging machine 1602. A belt cleaner 1606 may be provided on the conveyor 1604 to remove any seed treatment residue from the conveyor so that it does not collet on the conveyor. In one embodiment, the belt cleaner 1606 comprises a series of brushes for brushing treatment residue from the conveyor 1604.

In view of the foregoing, it will be understood that the following has been developed:

A1. A method of processing cottonseed, the method comprising:

applying an acid solution to a quantity of fuzzy cottonseed within an acid application device;

transferring, after said applying the acid solution, the quantity of fuzzy cottonseed to a seed washing station including a bath of liquid and a transporter running through the bath; and

washing the quantity of fuzzy cottonseed in the bath of liquid by submerging the cottonseed in the bath of liquid and transporting the cottonseed through the bath with the transporter.

A2. The method of A1, wherein the transporter comprises a pair of conveyors, the fuzzy cottonseed being held between the pair of conveyors to deliver the cottonseed through the bath of liquid.

A3. The method of A1, wherein the seed washing station includes first and second baths of liquid, the first bath including water and the second bath including a neutralization solution.

A4. The method of A1, further comprising heating the bath of liquid.

B1. A method of processing cottonseed, the method comprising:

applying an aqueous acid to a quantity of fuzzy cottonseed within an acid application device;

transferring, after said applying the aqueous acid, the quantity of fuzzy cottonseed to a buffing drum station including a rotatable, horizontal buffing drum having internal agitation paddles for buffing the cottonseed; and

buffing the quantity of fuzzy cottonseed in the buffing drum to remove linters from the fuzzy cottonseed.

B2. The method of B1, further comprising adjusting an orientation of the internal agitation paddles to impart a desired movement of the cottonseed in the buffing drum.

B3. The method of B1, further comprising supplying heated air to the buffing drum to reduce an external moisture content of the cottonseed.

One or more embodiments of the seed processing plant described above provides a useful and novel process that allows for more gentle processing of cotton seed to minimize seed damage and loss through sorting technologies that identify and reject damaged, low quality seed in an automated, high-throughput manner resulting in a higher quality final product while being more sustainable to the environment.

Modifications and variations of the disclosed embodiments are possible without departing from the scope of the invention defined in the appended claims. For instance, any station of the disclosed process may be bypassed or omitted based on the desired treatment of the seed. Additionally, seed may be removed from the process along any point for inspection or for being sent to waste, and the control system may be configured to cease operation of the treatment process if the seed is determined to not be flowing along any point of the process.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method of processing cottonseed, the method comprising:
applying an acid solution to a quantity of fuzzy cottonseed within an acid application device;
transferring, after said applying the acid solution, the quantity of fuzzy cottonseed to a fluid bed dryer station; and
drying, at least partially, the quantity of fuzzy cottonseed at the fluid bed dryer station.

2. The method of claim 1, wherein the acid application device comprises a rotatable drum including internal baffles on an interior surface of the drum.

3. The method of claim 2, wherein the rotatable drum is angled relative to horizontal to facilitate movement of the cottonseed from an inlet of the drum to an outlet of the drum.

4. The method of claim 1, wherein the acid application device includes a spray bar, said applying the acid solution to the quantity of fuzzy cottonseed comprising spraying the acid solution onto the cottonseed with the spray bar.

5. The method of claim 1, wherein drying the quantity of fuzzy cottonseed comprises supplying heated air to the cottonseed with a fluid bed dryer at temperatures of between about 150° F. (65° C.) to about 300° F. (149° C.).

6. The method of claim 1, further comprising detecting a moisture of the fuzzy cottonseed after exiting the fluid bed dryer.

7. The method of claim 1, further comprising storing the quantity of fuzzy cottonseed in storage bins prior to applying the acid solution to the cottonseed, each storage bin including an aeration system.

8. The method of claim 1, further comprising transferring, after said drying, the quantity of fuzzy cottonseed to a buffing drum station including a rotatable, horizontal buffing drum having internal agitation paddles for buffing the cottonseed; and
buffing the quantity of fuzzy cottonseed in the buffing drum to remove linters from the fuzzy cottonseed.

9. The method of claim 8, further comprising adjusting an orientation of the internal agitation paddles to impart a desired movement of the cottonseed in the buffing drum.

10. The method of claim 8, further comprising supplying heated air to the buffing drum to reduce an external moisture content of the cottonseed.

11. A method of processing cottonseed, the method comprising:
applying an acid solution to a quantity of fuzzy cottonseed within an acid application device;
transferring, after said applying the acid solution, the quantity of fuzzy cottonseed to a seed neutralization station including a neutralization device; and
neutralizing the acid solution on the quantity of fuzzy cottonseed in the neutralization device by at least one of submerging the cottonseed in a neutralization solution bath and spraying a neutralization solution on the cottonseed in the neutralization device.

12. The method of claim 11, wherein transferring the quantity of fuzzy cottonseed to said seed neutralization station comprises bypassing another seed neutralization station before transferring the cottonseed to said seed neutralization station.

13. The method of claim 12, further comprising determining, using a controller, to which neutralization station to transfer the quantity of fuzzy cottonseed.

14. The method of claim 11, wherein neutralizing the acid solution on the fuzzy cottonseed is done by spraying the neutralization solution on the cottonseed in the neutralization device, the neutralization device comprising a rotary device configured to spin the cottonseed in the rotary device.

15. The method of claim 11, further comprising:
transferring, after neutralizing the acid solution, the quantity of fuzzy cottonseed to a fluid bed dryer station; and
drying, at least partially, the quantity of fuzzy cottonseed at the fluid bed dryer station.

16. The method of claim 15, further comprising detecting a moisture of the fuzzy cottonseed after exiting a fluid bed dryer at the fluid bed dryer station.

17. A seed processing system comprising:
an acid application station including an acid application device for applying an acid solution to a quantity of fuzzy cottonseed;
a neutralization station including a neutralization device for neutralizing the acid solution on the quantity of fuzzy cottonseed; and
a fluid bed dryer station including a fluid bed dryer for drying, at least partially, the quantity of fuzzy cottonseed.

18. The system of claim 17, wherein the acid application device comprises a rotatable drum including internal baffles on an interior surface of the drum.

19. The system of claim 18, wherein the rotatable drum is angled relative to horizontal to facilitate movement of the cottonseed from an inlet of the drum to an outlet of the drum.

20. The system of claim 17, wherein the acid application device includes a spray bar configured to spray the acid solution onto the cottonseed.
